(19) United States
(12) Patent Application Publication
(10) Pub. No.: US 2026/0227867 A1
(43) Pub. Date: Aug. 6, 2026

(54) DISPLAY APPARATUS AND CONTROL METHOD THEREOF

(71) Applicant: SAMSUNG ELECTRONICS CO., LTD., Suwon-si (KR)

(72) Inventors: Md Abdul MAZED, Dhaka (BD); Muhammad ABUL KASHEM, Dhaka (BD); Golam RABBI, Dhaka (BD); Junaid Bin AHSAN, Dhaka (BD)

(73) Assignee: SAMSUNG ELECTRONICS CO., LTD., Suwon-si (KR)

(21) Appl. No.: 19/563,418

(22) Filed: Mar. 11, 2026

Related U.S. Application Data
(63) Continuation of application No. PCT/KR2026/001925, filed on Feb. 2, 2026.

(30) Foreign Application Priority Data
Feb. 5, 2025 (KR) 10-2025-0014252

(51) Int. Cl. G06F 3/0346; G06F 3/01; G06F 3/038

(52) U.S. Cl. CPC G06F 3/0346; G06F 3/011; G06F 3/038; G06F 2203/0331

(57) ABSTRACT

There is provided a display apparatus that receives, from an external apparatus, first sensing data generated by a second motion of the external apparatus according to a first motion of a body through the communication circuitry, obtains biological motion information corresponding to the first motion based on the first sensing data, obtains cursor movement information corresponding to the biological motion information, and controls a display to display a screen in which a cursor moved from a first location to a second location based on the cursor movement information.

### CROSS-REFERENCE TO RELATED APPLICATIONS

This application is a continuation application, claiming priority under 35 U.S.C. § 365(c), of an International application No. PCT/KR2026/001925, filed on February 2, 2026, which is based on and claims the benefit of a Korean patent application number 10-2025-0014252, filed on February 5, 2025, in the Korean Intellectual Property Office, the disclosure of which is incorporated by reference herein in its entirety.

### TECHNICAL FIELD

The disclosure relates to a display apparatus and a control method thereof, and more particularly, to a display apparatus that displays a screen wherein a cursor moved based on a biological motion for the display apparatus, and a control method thereof.

### BACKGROUND

As electronic technologies developed, development of technologies for various types of electronic apparatuses is becoming active. Among them, an electronic apparatus such as a wearable apparatus that analyzes physical data of a user and provides the data to the user or to an apparatus like a display apparatus is also developing.

In particular, recently, various electronic apparatuses that can provide a control function according to a physical motion of a user who is wearing a wearable apparatus are being developed. For example, a wearable apparatus that can be used with a specific electronic apparatus can detect a physical motion of a user, and the electronic apparatus can provide a function corresponding to the physical motion of the user to the user by using sensing data that the wearable apparatus detected and obtained.

### DISCLOSURE

### Technical Solution

There is provided a display apparatus that may include: memory storing instructions; communication circuitry; a display configured to display a cursor; and at least one processor may include processing circuitry, wherein the instructions, when executed by the at least one processor individually or collectively, cause the display apparatus to: receive, from an external apparatus, through the communication circuitry, and according to a first motion of a body, first sensing data generated by a second motion of the external apparatus, obtain, based on the first sensing data, biological motion information corresponding to the first motion, obtain cursor movement information corresponding to the biological motion information, and control the display to display a screen wherein the cursor is, based on the cursor movement information, moved from a first location to a second location.

The display apparatus further may include: an ultra-wide band (UWB) sensor, wherein the instructions, when executed by the at least one processor individually or collectively, may further cause the display apparatus to: obtain, from the UWB sensor, a distance between the external apparatus and the display apparatus, and based on determining the distance to be smaller than a defined distance, receive the first sensing data through the communication circuitry.

The display apparatus further may include: at least one motion sensor configured to sense a third motion of the display apparatus, wherein the instructions, when executed by the at least one processor individually or collectively, may further cause the display apparatus to: based further on identifying that second sensing data is matched with the first sensing data, obtain the biological motion information, and the second sensing data is obtained from the at least one motion sensor.

The instructions, when executed by the at least one processor individually or collectively, may further cause the display apparatus to: obtain the biological motion information from a first neural network model that is trained to output the biological motion information according to previous sensing data and a first previous motion of the body.

The first neural network model may be further trained to, based on the previous sensing data, output the biological motion information as further according to a second previous motion, and the previous sensing data may include first previous sensing data and second previous sensing data, the first previous sensing data is obtained by sensing the second previous motion of the external apparatus, and the second previous motion of the external apparatus is obtained by sensing the first previous motion.

The second previous sensing data may include image data obtained by capturing, a plurality of times, the first previous motion in each of a plurality of directions, and the first neural network model may be further trained to output the biological motion information as including a direction of the plurality of direction and corresponding to the second previous motion.

The instructions, when executed by the at least one processor individually or collectively, may further cause the display apparatus to: obtain the cursor movement information from a second neural network model trained to output the cursor movement information according to previous sensing data and a first previous motion of the body.

The second neural network model may be further trained to, based on the previous sensing data, output the cursor movement information according to a test cursor and the first previous motion of the body, and the previous sensing data is data obtained by sensing a second previous motion of the external apparatus, and the second previous motion of the external apparatus is corresponding to a movement of the test cursor.

The display apparatus further may include: an ultra-wide band (UWB) sensor, wherein the instructions, when executed by the at least one processor individually or collectively, may further cause the display apparatus to: obtain a distance between the external apparatus and the display apparatus based on first initial sensing data obtained through the UWB sensor, identify, according to whether the distance is determined to be smaller than a defined distance, whether the cursor was activated, and based on identifying that the cursor was activated, receive the first sensing data.

The display apparatus, further may include: at least one motion sensor configured to sense a third motion of the display apparatus, wherein the instructions, when executed by the at least one processor individually or collectively, may further cause the display apparatus to: based on the distance being determined to be smaller than the defined distance, receive, from the external apparatus and through the communication circuitry, second initial sensing data generated by a gesture activating the cursor, based on identifying that third initial sensing data and the second initial sensing data are matched with a defined gesture pattern, identify that the cursor was activated, the third initial sensing data is obtained by sensing a motion corresponding to the gesture through the at least one motion sensor, and control the display to display the cursor.

There is provided a control method of a display apparatus, the method may include: receiving, from an external apparatus and according to a first motion of a body, first sensing data generated by a second motion of the external apparatus; obtaining, based on the first sensing data, biological motion information corresponding to the first motion; obtaining cursor movement information corresponding to the biological motion information; and displaying a screen wherein a cursor is, based on the cursor movement information, moved from a first location to a second location.

Receiving the first sensing data may include: obtaining, from a UWB sensor, a distance between the external apparatus and the display apparatus; and based on determining the distance to be smaller than a defined distance, receiving the first sensing data.

Obtaining the biological motion information may include, based further on identifying, that second sensing data is matched with the first sensing data, obtaining the biological motion information, and the second sensing data is obtained through at least one motion sensor configured to sense a third motion of the display apparatus.

Obtaining the biological motion information may include: obtaining the biological motion information from a first neural network model that is trained to output the biological motion information according to previous sensing data and a first previous motion of the body.

There is provided a non-transitory computer-readable recording medium storing computer instructions which, when executed by a processor of a display apparatus, cause the display apparatus to perform operations may include: receiving, from an external apparatus and according to a first motion of a body, first sensing data generated by a second motion of the external apparatus; obtaining, based on the first sensing data, biological motion information corresponding to the first motion; obtaining cursor movement information corresponding to the biological motion information; and displaying a screen wherein a cursor is, based on the cursor movement information, moved from a first location to a second location.

### BRIEF DESCRIPTION OF DRAWINGS

FIG. 1 is a diagram for schematically illustrating an operation of a display apparatus according to one or more embodiments of the disclosure;

FIG. 2 is a block diagram for illustrating a configuration of a display apparatus according to one or more embodiments of the disclosure;

FIG. 3 is a detailed block diagram for illustrating a detailed configuration of a display apparatus according to one or more embodiments of the disclosure;

FIG. 4 is a diagram for illustrating an operation of an electronic apparatus according to one or more embodiments of the disclosure;

FIG. 5 is a diagram for illustrating sensing data according to one or more embodiments of the disclosure;

FIG. 6 is a diagram for illustrating aspects of a first neural network model and a second neural network model according to one or more embodiments of the disclosure;

FIG. 7 is a diagram for illustrating aspects of a first neural network model according to one or more embodiments of the disclosure;

FIG. 8 is a flow chart for illustrating aspects of a first neural network model according to one or more embodiments of the disclosure;

FIG. 9 is a diagram for illustrating aspects of a second neural network model according to one or more embodiments of the disclosure;

FIG. 10 is a diagram for illustrating aspects of a second neural network model according to one or more embodiments of the disclosure;

FIG. 11 is a flow chart for illustrating aspects of a second neural network model according to one or more embodiments of the disclosure;

FIG. 12 is a diagram for illustrating an operation of activating a cursor according to one or more embodiments of the disclosure; and

FIG. 13 is a flow chart for illustrating a control method of a display apparatus according to one or more embodiments of the disclosure.

### MODE FOR INVENTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents, and/or alternatives of the embodiments of the disclosure. Also, with respect to the detailed description of the drawings, similar components may be designated by similar reference numerals.

Also, in case it is determined that in describing the disclosure, detailed explanation of related known functions or components may unnecessarily confuse the gist of the disclosure, the detailed explanation will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, terms used in the disclosure are just used to explain specific embodiments, and are not intended to limit the scope of protection of the disclosure. In addition, singular expressions include plural expressions, unless defined obviously differently in the context.

Also, in the disclosure, expressions such as “have,” “may have,” “include,” and “may include” denote the existence of such characteristics (e.g., elements such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

In contrast, the description that one element (e.g., a first element) is “directly coupled” or “directly connected” to another element (e.g., a second element) can be interpreted to mean that still another element (e.g., a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g., an embedded processor) for performing the corresponding operations, or a generic-purpose processor (e.g., a CPU or an application processor) that can perform the corresponding operations by executing one or more software programs stored in a memory apparatus.

Also, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, embodiments according to the disclosure will be described in detail with reference to the accompanying drawings, such that those having ordinary skill in the art to which the disclosure belongs can easily carry out the disclosure.

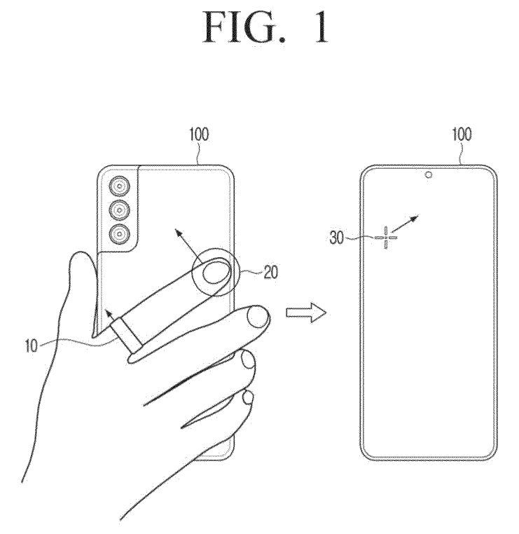

FIG. 1 is a diagram for schematically illustrating an operation of a display apparatus according to one or more embodiments of the disclosure

According to FIG. 1, a display apparatus 100 and an external apparatus 10 are illustrated.

The display apparatus 100 may be an apparatus that outputs an image through a display. The display apparatus 100 may be implemented as apparatuses such as a mobile phone, a smartphone, etc., but is not limited thereto, and it may be implemented as various types of display apparatuses equipped with a display such as a TV, a monitor, a laptop PC, a tablet PC, a video wall, a large format display (LFD), digital signage, a digital information display (DID), a projector display, a kiosk, an electronic blackboard, a refrigerator, an air conditioner, etc. Also, the display apparatus 100 may be implemented as various display apparatuses such as a set-top box, a PC, or a home server, etc. that do not include a display in themselves, and are used by being connected with an external display apparatus (e.g., a TV or a monitor, etc.).

Alternatively, the display apparatus 100 can not only be implemented as the aforementioned various independent apparatuses, but can also be implemented in a form of a display panel or a module that can be applied to such apparatuses.

The external apparatus 10 may be implemented as a display apparatus that can be used together with the display apparatus 100. For example, the external apparatus 10 may be implemented as a wearable apparatus.

A wearable apparatus is an apparatus implemented in a form of being worn on a user or being attached to or inserted into the skin, and it may be a smart watch, a smart band, smart glasses, a smart ring, a head mounted display (HMD), etc. However, the disclosure is not limited thereto, and any apparatus can be a wearable apparatus if it is a display apparatus implemented in a form of being worn on a user or being attached to or inserted into the skin.

In case the external apparatus 10 is implemented as a smart ring among wearable apparatuses, the external apparatus 10 may be implemented in a form that can be worn on a user’s finger.

In this case, the external apparatus 10 may obtain sensing data by detecting a motion (an arrow) of a finger (e.g., an index finger) for which the external apparatus 10 is used. Here, the motion of the finger may mean a motion of a fingertip 20. The fingertip may mean the end portion of a distal phalanx in the finger wearing the external apparatus 10.

Here, the sensing data may fall under data obtained by the external apparatus 10 by detecting acceleration, angular acceleration, speed, displacement, etc. for the user’s movement.

The external apparatus 10 may transmit the collected sensing data to the display apparatus 100. Here, the display apparatus 100 may be implemented as an apparatus that can be paired with the external apparatus 10. Here, paring may mean a process wherein mutual recognition and data exchange, etc. are made possible between the external apparatus 10 such as a smart ring and the display apparatus 100 such as a smartphone through wireless communication.

In case the display apparatus 100 received data regarding the motion (the arrow) of the finger from the external apparatus 10, the display apparatus 100 may display a screen wherein the cursor 30 was moved to correspond to the motion of the finger. Here, the data received by the display apparatus 100 may include information regarding the moving direction, the speed, etc. of the user’s finger.

Here, the cursor 30 may mean a graphic element that indicates a selected location on a user interface. The cursor 30 may move on the screen through a touch input or control by the external apparatus.

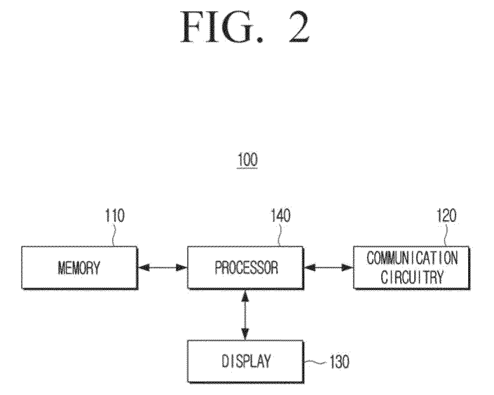

Like this, the display apparatus 100 may obtain information on a movement of the cursor 30 by processing sensing data received from the external apparatus 10, etc. Detailed operations in this regard will be described through FIG. 2, etc. that will be described below.

FIG. 2 is a block diagram for illustrating a configuration of a display apparatus according to one or more embodiments of the disclosure.

According to FIG. 2, the display apparatus 100 may include memory 110, communication circuitry 120, a display 130, and a processor 140.

As the display apparatus 100 was explained in FIG. 1, overlapping explanation will be omitted.

The memory 110 may be electrically connected with the at least one processor 140, and store data necessary for the various embodiments of the disclosure. For example, the memory 110 may be implemented as internal memory such as read-only memory (ROM) (e.g., electrically erasable programmable read-only memory (EEPROM)), random access memory (RAM), etc., included in the at least one processor 140, or implemented as separate memory from the at least one processor 140.

The memory 110 may be implemented in the form of memory embedded in the display apparatus 100, or implemented in the form of memory that can be attached to or detached from the display apparatus 100 according to the use of stored data. For example, in the case of data for driving the display apparatus 100, the data may be stored in memory embedded in the display apparatus 100, and in the case of data for an extended function of the display apparatus 100, the data may be stored in memory that can be attached to or detached from the display apparatus 100. In the case of being implemented as memory embedded in the display apparatus 100, the memory 110 may be at least one of volatile memory (e.g., dynamic RAM (DRAM), static RAM (SRAM), or synchronous dynamic RAM (SDRAM), etc.) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)).

Meanwhile, in the illustrated example, it was illustrated that the display apparatus 100 consists of one memory, but in the case of referring to the display apparatus 100 by dividing volatile memory and non-volatile memory, the display apparatus 100 may be referred to as including a plurality of memories.

The memory 110 according to one or more embodiments may include at least one instruction. Here, the at least one instruction may fall under at least one instruction that makes the display apparatus 100 display a screen wherein the location of the cursor was moved. The memory 110 may store information necessary for the operations of the display apparatus 100 other than this.

For example, the memory 110 may store at least one neural network model. The neural network model consists of machine learning (deep learning) technologies using an algorithm of classifying/learning the characteristics of input data by itself, and element technologies of simulating functions of a human brain such as cognition, determination, etc. by utilizing a machine learning algorithm.

Here, the neural network model may also be referred to as a learning model, an AI model, a deep learning model, etc.

Element technologies may include, for example, at least one of a linguistic understanding technology of recognizing languages/characters of humans, a visual understanding technology of recognizing an object in a similar manner to human vision, an inference/prediction technology of judging information and then making logical inference and prediction, or a knowledge representation technology of processing information of human experiences into knowledge data.

For example, the neural network model may fall under at least one of a first neural network model or a second neural network model for displaying a screen wherein the cursor moved. The first neural network model and the second neural network model will be described in detail in the parts described below.

The neural network model is not limited to the aforementioned examples, and the neural network model may be implemented as various models for the display apparatus 100 to display a screen wherein the cursor moved.

The communication circuitry 120 may perform data communication with an external electronic apparatus by control by the processor 140. For example, the communication circuitry 120 may communicate with an external electronic apparatus through a network. For example, the processor 140 may receive data from an external electronic apparatus through the communication circuitry 120, and transmit data to the external electronic apparatus through the communication circuitry 120.

The communication circuitry 120 may include hardware components for supporting transmission and/or reception of electric signals between the display apparatus 100 and the external apparatus. For example, the communication circuitry 120 may support transmission and/or reception of electric signals based on various types of protocols such as Ethernet, a local area network (LAN), a wide area network (WAN), wireless fidelity (Wi-Fi), Bluetooth, Bluetooth Low energy (BLE), Zigbee, Long Term Evolution (LTE), 5G new radio (NR), and/or 6G.

According to one or more embodiments, the display apparatus 100 may receive first sensing data generated by a second motion of the external apparatus according to a first motion through the communication circuitry 120. Here, the first motion may mean a motion of a body. For example, a motion of a body may mean a motion of a part of the user’s body such as a finger for moving the cursor displayed on the display apparatus 100, etc.

Here, the second motion may fall under a motion of the external apparatus according to the first motion. For example, in case the external apparatus worn on a finger moved by the first motion of the user’s finger, the second motion may mean this motion.

Here, the first sensing data may fall under data that the external apparatus obtained by sensing the second motion. For example, the external apparatus may detect a motion of the external apparatus (itself) by the second motion, and obtain the first sensing data including information regarding speed, acceleration, and displacement, etc.

Meanwhile, the display apparatus 100 may include a display 130.

The display 130 is a component for displaying an operation state of the display apparatus 100 or a notification message, a UI screen, etc. The display 130 may be implemented as displays in various forms such as a liquid crystal display (LCD), an organic light emitting diodes (OLED) display, a plasma display panel (PDP), etc. Inside the display 130, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. Meanwhile, the display 130 may be implemented as a touch screen combined with a touch sensor, a flexible display, a three-dimensional (3D) display, etc. Alternatively, the display 130 may be implemented only as one or a plurality of light emitting elements.

The display apparatus 100 may change the display state of the display 130 according to various states such as when the display apparatus 100 is in a turned-on state, when the display apparatus 100 is operating normally, when power is insufficient or when there is an error, etc., and may thereby make the user identify the state of the display apparatus 100 intuitively.

The processor 140 may perform overall control operations of the display apparatus 100.

The processor 140 may be implemented as a digital signal processor (DSP) processing digital signals, a microprocessor, and a time controller (TCON). However, the disclosure is not limited thereto, and the processor 140 may include one or more of a central processing unit (CPU), a micro controller unit (MCU), a micro processing unit (MPU), a controller, an application processor (AP), a graphics-processing unit (GPU) or a communication processor (CP), and an ARM processor, or may be defined by the terms. Also, the processor 140 may be implemented as a system on chip (SoC) having a processing algorithm stored therein or large scale integration (LSI), or in the form of a field programmable gate array (FPGA). In addition, the processor 140 may perform various functions by executing computer executable instructions stored in the memory. Meanwhile, in FIG. 2, it was illustrated that only one processor is included in the display apparatus 100, but in actual implementation, a plurality of processors (e.g., a CPU + a GPU, a CPU + a DSP) may be included.

Meanwhile, the instructions stored in the memory 110 described above may, when executed by the processor 140 individually or collectively, cause the display apparatus 100 to perform operations as follows.

According to one or more embodiments, the display apparatus 100 may receive, from an external apparatus, first sensing data generated by a second motion of the external apparatus according to a first motion of a body through the communication circuitry. As explanation in this regard was described above, overlapping explanation will be omitted.

According to one or more embodiments, the display apparatus 100 may obtain biological motion information corresponding to the first motion based on the first sensing data. Here, as the first sensing data was explained in detail above, overlapping explanation will be omitted.

Here, the biological motion information may fall under motion information corresponding to the first motion. Here, as the first motion was explained above, overlapping explanation will be omitted. The biological motion information may include physical information regarding movements of a body such as acceleration, speed, and displacement, etc. of the first motion of the body (e.g., a fingertip).

Here, the displacement of the body may mean the distance and the direction in which the body moved. For example, the displacement may be expressed as a virtual coordinate based on the location of the display apparatus 100. In other words, the displacement may be expressed in a form of a vector based on a new location to which the body moved from the initial location of the body.

For example, the display apparatus 100 may obtain information on a motion of a fingertip from the first sensing data regarding a motion of the external apparatus. Here, the fingertip may fall under a fingertip of the finger that is wearing the external apparatus.

In other words, a motion of the fingertip may not coincide with a motion of the external apparatus, but the display apparatus 100 may recognize a motion of the fingertip by using the first sensing data regarding a motion of the external apparatus.

Specifically, the display apparatus 100 may recognize a motion of the fingertip from a motion of the external apparatus by using mapping information. For example, the display apparatus 100 may patternize specific parameters (e.g., acceleration, speed, a tilt, etc.) included in the previously obtained first sensing data (the first previous sensing data), and map each of the plurality of patterns to each type of motions of the fingertip (e.g., up, down, left, right, etc.).

In the mapping information, such a plurality of patterns may be stored in a form of being mapped to each type of motions of the fingertip.

Here, patternizing may mean that the external apparatus patternizes a form of a waveform of a specific parameter into a similar form from the first sensing data that the external apparatus obtained by sensing several motions of the external apparatus by a plurality of times.

Meanwhile, the display apparatus 100 may obtain biological motion information from the previous sensing data by using a trained neural network model.

According to one or more embodiments, the display apparatus 100 may obtain biological motion information through a first neural network model. Here, the first neural network model may fall under a model that was trained to output biological motion information corresponding to a first previous motion of the body based on the previous sensing data.

Here, the previous sensing data may fall under the previous data that the external apparatus 10 or other apparatuses obtained by sensing a motion of the body (e.g., the user’s finger) before the current time point. Here, the previous data may be used as training data for training the first neural network model.

Here, the biological motion information may fall under motion information corresponding to the first previous motion. Here, the first previous motion may mean a motion of the body before the current time point.

Specifically, the first neural network model may be trained by using the previous sensing data (training data) obtained by sensing both of a motion of the external apparatus and a motion of the body corresponding thereto.

As an example, the first neural network model may fall under a model that was trained to, based on the previous sensing data including the first previous sensing data and the second previous sensing data, output biological motion information corresponding to the second previous motion.

Here, the first previous sensing data may fall under data obtained by sensing the second previous motion of the external apparatus. Here, the second previous motion may fall under a motion of the external apparatus in case the external apparatus moved according to the aforementioned first previous motion. Here, the first previous motion may fall under a motion of the body for collecting training data.

Specifically, the motion for collecting training data may fall under a motion performed prior to the aforementioned second motion, and may fall under data for being input into the first neural network model in a process of training the first neural network model.

Here, the second previous sensing data may fall under data obtained by sensing the first previous motion. Here, the first previous motion is a motion performed prior to the aforementioned first motion, and may fall under a motion of the body for collecting training data.

Specifically, the motion for collecting training data may fall under a motion performed prior to the aforementioned first motion, and may fall under data for being input into the first neural network model in a process of training the first neural network model.

For example, the user may move the body such as a finger in a process wherein the display apparatus 100 trains the first neural network model. Here, the finger may fall under a finger that is wearing the external apparatus such as a smart ring.

The display apparatus 100 may obtain the second previous sensing data by sensing a motion of the body. The display apparatus 100 may receive the first previous sensing data regarding a motion of the external apparatus according to a motion of the body from the external apparatus.

The display apparatus 100 may train the first neural network model by using the data including the first previous sensing data and the second previous sensing data as training data. Here, the first neural network model may be trained to output information on a motion of a finger (biological motion information). In this process, a label regarding the first neural network model may be obtained based on the second previous sensing data.

For example, the second previous sensing data may include image data. Here, the image data may fall under image data that was obtained by capturing the first previous motion in each of a plurality of directions by a plurality of times.

Here, each of the plurality of directions may fall under a direction in which the body moves. For example, the plurality of directions may include up, down, left, right, etc.

Here, the display apparatus 100 may direct a direction to the user through the display 130. The display apparatus 100 may display a UI (e.g., an arrow), and the user may move a finger viewing the UI. Accordingly, the user’s fingertip may move to a specific location from the initial location according to the directed direction.

The display apparatus 100 may obtain image data by sensing the fingertip by a plurality of times while the fingertip moves to a specific location from the initial location. For example, the display apparatus 100 may sense the fingertip through a camera.

Here, the display apparatus 100 may sense the fingertip by a defined interval based on a user manipulation input for capturing the fingertip, but this is merely an example, and the display apparatus 100 may sense the fingertip by a defined interval when a motion of the fingertip is detected.

The display apparatus 100 may sense a plurality of images by sensing the fingertip by the defined interval by a plurality of times. Here, each of the plurality of images may fall under an image that captured the fingertip sequentially according to a movement of the fingertip. The display apparatus 100 may obtain image data including such a plurality of images.

The display apparatus 100 may obtain training data by labeling the first previous sensing data. Here, labeling may mean a process of connecting the first previous sensing data with a correct answer value (a label).

Here, the correct answer value may be obtained from image data including a plurality of images for a specific direction. For example, the display apparatus 100 may identify a direction of the fingertip by analyzing the plurality of images.

The display apparatus 100 may obtain data labeled for each of the plurality of directions by repeating the aforementioned process for each of the plurality of directions.

The display apparatus 100 may train the first neural network model based on the second previous sensing data and the first previous sensing data as described above.

The first neural network model may fall under a model trained to output biological motion information including a direction corresponding to the second previous motion among the plurality of directions.

The display apparatus 100 may obtain biological motion data corresponding to the second motion of the external apparatus by inputting the sensing data obtained by sensing the second motion (the first sensing data) into the first neural network model trained as above.

All or some of the aforementioned processes may be performed in an external apparatus (e.g., a smart ring) that can be used with the display apparatus or other external apparatuses (e.g., a server apparatus, etc.).

Meanwhile, the display apparatus 100 may obtain cursor movement information based on the biological motion data obtained as above through a separate neural network model.

According to one or more embodiments, the display apparatus 100 may obtain cursor movement information through the second neural network model. Here, the second neural network model may fall under a model trained to output cursor movement information corresponding to the first previous motion of the body based on the previous sensing data.

Here, the first previous motion of the body may fall under the previous motion of the body for training the second neural network model. As explanation in this regard was described above, overlapping explanation will be omitted.

According to one or more embodiments, the display apparatus 100 may obtain cursor movement information corresponding to the biological motion information.

Here, the cursor movement information may mean data including information such as a starting coordinate, a target coordinate, and a moving path between them, speed, a direction, etc. in a process where the cursor moves.

The coordinates in the starting coordinate and the target coordinate may mean specific locations on the display 130.

Here, the cursor may move by a user input, etc. Here, the user input may fall under an input signal that is input through an external apparatus. In other words, the user input may fall under a signal that is input according to a motion of an external apparatus by a motion of the user’s body. Here, the external apparatus may convert the motion of the external apparatus into electric data, and transmit the data in a form of an input signal to the display apparatus 100.

Meanwhile, the display apparatus 100 may obtain cursor movement information from the biological motion information by using mapping information. For example, the display apparatus 100 may patternize specific parameters (e.g., acceleration, speed, a tilt, etc.) included in the previously obtained first sensing data (the first previous sensing data), and map each of the plurality of patterns to each type of motions of the cursor (e.g., up, down, left, right, etc.).

In the mapping information, such a plurality of patterns may be stored by being mapped to each type of the biological motion information.

Here, patternizing may mean that the external apparatus patternizes a form of a waveform of a specific parameter into a similar form from the first sensing data that the external apparatus obtained by sensing several motions of the external apparatus a plurality of times.

Alternatively, the display apparatus 100 may obtain biological motion information from the first previous sensing data, and map each type of the biological motion information (e.g., types for each of the moving directions of a fingertip) to each type of motions of the cursor.

In the mapping information, the types of the biological motion information may be stored by being mapped to each type of the biological motion information.

Meanwhile, the display apparatus 100 may obtain the biological motion information by using a neural network model trained from the previous sensing data.

According to one or more embodiments, the display apparatus 100 may obtain the cursor movement information through the second neural network model. Here, the second neural network model may fall under a model trained to output cursor movement information corresponding to the first previous motion of the body based on the previous sensing data.

The second neural network model may fall under a model trained by using the previous sensing data and other data obtained therefrom as training data. Here, the external apparatus may obtain the previous sensing data according to the first previous motion of the body.

For example, in case the external apparatus moves according to the first previous motion of the body, the external apparatus may obtain the previous sensing data by sensing a movement of the external apparatus. As the other previous sensing data was explained above, overlapping explanation will be omitted.

Meanwhile, the cursor movement information corresponding to the first previous motion may include information on a (target) location to which the cursor should move according to the previous motion of the body, a moving path, speed, etc.

The second neural network model may be trained through training data regarding movements of the cursor, so as to output the cursor movement information as above.

Here, the training data regarding movements of the cursor may be obtained from a previous input of the user for moving the cursor to a specific location (or direction). Here, the previous input of the user may fall under an input signal for moving the cursor displayed temporarily on the display 130, etc.

According to one or more embodiments, the second neural network model may fall under a model trained to output cursor movement information corresponding to the first previous motion for moving and displaying a test cursor based on the previous sensing data.

Here, the previous sensing data may fall under data obtained by sensing the second previous motion of the external apparatus. Here, the second previous motion may fall under a previous motion corresponding to a movement of the test cursor displayed on the display apparatus.

Here, the test cursor may mean a cursor that can be displayed on the display 130 for collecting training data. The display apparatus 100 may display a screen on which the test cursor moves through the display 130. The display apparatus 100 may induce the user to move the body such as a finger according to a movement of the test cursor through the screen.

For example, the user may view the screen on which the test cursor moves, and move a finger for moving the test cursor like the test cursor displayed on the screen. Here, the finger may fall under a finger that is wearing the external apparatus. Here, the user may move a fingertip while contacting the fingertip on the rear surface of the display apparatus 100 in a state of gripping the display apparatus 100.

Specifically, in case the test cursor was moved from a specific starting location to a specific target location, the user may move the fingertip such that the cursor moves from the starting location to the target location. In other words, the user may move the fingertip as if to control the cursor by the fingertip by using the rear surface of the display apparatus 100 like a track pad (or a touch pad).

The user may tap or double tap a specific location of the rear surface of the display apparatus 100 before moving a fingertip. Then, the user may move the fingertip while the fingertip contacts the rear surface of the display apparatus 100 for moving the test cursor. The user may tap or double tap again when the movement of the fingertip is completed.

The external apparatus or the display apparatus 100 may obtain the previous sensing data by sensing a motion of the fingertip. Specifically, the external apparatus or the display apparatus 100 may recognize start of a fingertip motion through a tap or a double tap, and recognize ending of the fingertip motion through a tap or a double tap afterwards.

Here, the external apparatus or the display apparatus 100 may store a pattern corresponding to a tap or a double tap in advance, and when the previous sensing data matched with the stored pattern is obtained, recognize it as start or ending of the biological motion.

The display apparatus 100 may label the previous sensing data obtained by the external apparatus or the display apparatus 100. For example, in case the display apparatus 100 obtained the previous sensing data according to a screen that induces a movement of the test cursor in a specific direction, the display apparatus 100 may label the obtained previous sensing data in the specific direction.

The display apparatus 100 may obtain training data by repeatedly performing labeling on the previous sensing data for each of a plurality of directions or a plurality of moving lengths.

The second neural network model may be trained to obtain cursor movement information corresponding to the first previous motion. For example, the cursor movement information corresponding to the first previous motion may mean information on a direction, speed, distance, etc. of a cursor movement determined according to the characteristics (a moving direction, speed, distance, etc.) of a biological motion of a specific user.

In other words, in case the second neural network model was trained to obtain cursor movement information as above, the second neural network model may obtain cursor movement information for moving the cursor by an appropriate degree according to the characteristics of a biological motion of a specific user. Here, the characteristics of the biological motion may be obtained from the sensing data.

According to one or more embodiments, the display apparatus 100 may control the display 130 to display a screen wherein the location of the cursor moved from the first location to the second location based on cursor movement information.

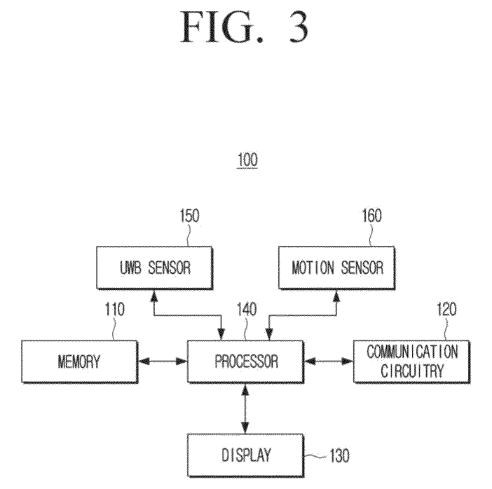

Here, the first location is an initial coordinate before the cursor movement, and may mean the location displayed on the screen before the cursor moved. For example, the first location may mean a location wherein the cursor was activated and initially displayed on the screen. Here, activation of the cursor will be described in detail later in FIG. 3.

The second location is the final coordinate after the cursor movement, and may mean a location wherein the cursor is newly displayed on the screen after the cursor moved. The display apparatus 100 may obtain the second location by using information on the moving degree of the cursor (the moving direction and distance, etc.) included in the cursor movement information from the first location.

The screen moved to the second location may mean a screen that was updated by reflecting the state wherein the cursor was changed from the first location to the second location according to the cursor movement information. Here, the updated screen may mean a screen that was changed from the screen wherein the cursor was displayed in the first location to the screen wherein the cursor was displayed in the second location.

As described above, the display apparatus 100 may change the location of the cursor based on a motion of the body wearing the external apparatus. Even when the user is not directly wearing the external apparatus on a part (e.g., a fingertip) of the body that the user substantially wants to move, the display apparatus 100 may predict a motion of the part of the body from a motion of the external apparatus.

As the display apparatus 100 can move the cursor to correspond to a predicted motion of a part of the body, even when the display apparatus 100 does not include a component such as a track pad (a touch pad), the user can be provided with a use experience of being able to control the display apparatus 100 through a virtual track pad.

In FIG. 2, it was illustrated that the display apparatus 100 includes only basic components, but the display apparatus 100 may further include various components other than the aforementioned components.

FIG. 3 is a detailed block diagram for illustrating a detailed configuration of a display apparatus according to one or more embodiments of the disclosure.

According to FIG. 3, the display apparatus 100 may include memory 110, communication circuit 120, a display 130, a processor 140, an ultra-wide band (UWB) sensor 150, and a motion sensor 160.

As the memory 110, the communication circuit 120, the display 130, and the processor 140 of the display apparatus 100 were explained in FIG. 2, overlapping explanation will be omitted.

The UWB sensor 150 may be a sensor for detecting a distance to an object around the display apparatus 100 by using a UWB signal. Here, the distance to an object may mean a distance to an external apparatus (or a separate UWB sensor included in an external apparatus). Also, the UWB sensor 150 may detect a change of a distance from the UWB sensor 150 to an object.

Specifically, the UWB sensor 150 may be implemented as an impulse-radio ultra wideband (IR-UWB) radar sensor. The IR-UWB radar sensor may identify a distance from the sensor 150 to an object or a location of an object by radiating an impulse signal of an ultra wideband to the object, and measuring the time that the signal reflected from the object is received.

In other words, the UWB sensor 150 may be a radar sensor that measures a location of an object by transmitting a signal by using a wide frequency bandwidth (e.g., 7500Mhz, etc.) with low power, and receiving the reflected signal. Here, the IR-UWB radar sensor may detect a slight change of a movement, and thus it can be used in measuring a slight movement, etc. of a finger of a person who is wearing an external apparatus like a smart ring.

The display apparatus 100 may include at least one UWB sensor 150, but is not limited thereto, and the sensor may be implemented as a plurality of UWB sensors 150. Hereinafter, explanation will be described by assuming a case wherein the UWB sensor 150 is implemented as at least one UWB sensor 150, for the convenience of explanation.

Meanwhile, in the disclosure, a distance to an external apparatus can be detected through the UWB sensor 150, but this is merely an example, and a motion of a body can be detected through various sensors for detecting a distance to an external apparatus of the body or the body such as a distance sensor, a LiDAR sensor, etc.

According to one or more embodiments, the display apparatus 100 may obtain a distance between an external apparatus and the display apparatus 100 through the UWB sensor 150. Here, the distance between the external apparatus and the display apparatus 100 may fall under a distance between the UWB sensors of each of the external apparatus and the display apparatus 100.

The display apparatus 100 may identify whether the obtained distance is smaller than a defined distance. Here, the defined distance may fall under a reference distance for determining whether the body wearing the external apparatus contacted the display apparatus 100 or is located in a close distance.

For example, in case the external apparatus is implemented as a smart ring, the display apparatus 100 may identify whether a fingertip portion of a finger wearing the smart ring contacted the rear surface of the display apparatus 100 or is located in a close distance.

If the obtained distance is smaller than the defined distance, the display apparatus 100 may receive the first sensing data through the communication circuitry 120. For example, if the obtained distance is smaller than the defined distance, the display apparatus 100 may recognize that the fingertip of the finger wearing the smart ring contacted the rear surface of the display apparatus 100 or is close to it, such as within a predetermined range which may regard value-to-value analysis per time, similarity of multiple values over some set amount of time, or the like.

In contrast, if the obtained distance is greater than or equal to the defined distance, the display apparatus 100 may recognize that the fingertip of the finger wearing the smart ring is located in a far distance from the display apparatus 100.

For example, in a state wherein the user is not gripping the display apparatus 100 (a state wherein the user placed the display apparatus 100 on a desk or put it in a pocket of pants, etc.), a motion of a finger may not fall under a motion for moving the cursor.

In other words, in case an external apparatus is far away from the display apparatus 100, sensing data obtained by the external apparatus (a smart ring, etc.) may not be received. Through this, in case the external apparatus is located in a distance greater than or equal to the reference distance, the display apparatus 100 may prevent a malfunction due to an unintentional motion. Here, a malfunction may mean a phenomenon wherein the cursor moves to an unintended location by an unintentional motion.

Meanwhile, the motion sensor 160 may mean a sensor that detects a change in a motion or a location of the user. The motion sensor 160 may include an IMU sensor, an infrared based motion detection sensor, a LiDAR sensor, an ultrasonic sensor, etc. Here, the inertial measurement unit (IMU) sensor is a sensor that analyzes motions and directions through inertial measurement and may be utilized as one of various motion sensors 160.

Specifically, the IMU sensor may include an accelerometer, a gyroscope, a magnetometer, etc. The accelerometer may measure an acceleration value of a segment (a body part, etc.) of the user, and the gyroscope may measure the rotation speed. Also, the magnetometer may perform a function of identifying a direction of the user by using the geomagnetic field.

The display apparatus 100 may include at least one motion sensor 160, but is not limited thereto, and the sensor may be implemented as a plurality of motion sensors 160. Hereinafter, explanation will be described by assuming a case wherein the motion sensor 160 is implemented as at least one motion sensor 160, for the convenience of explanation.

According to one or more embodiments, the motion sensor 160 may sense a third motion of the display apparatus 100. For example, in case a third motion (a first motion) according to a biological motion is generated, the motion sensor 160 may sense the third motion.

Here, the biological motion may fall under tapping or a swipe, etc. Here, the third motion according to the biological motion may fall under a motion that the display apparatus 100 is shaken according to a biological motion such as tapping the rear surface of the display apparatus 100. However, the disclosure is not limited thereto.

Here, a swipe may mean a gesture of continuously pushing the surface of the screen in a specific direction to move the screen by using a fingertip, etc. Tapping means a touch gesture of pressing the surface of the screen quickly during a short time by using a fingertip, etc. and then taking the fingertip off. However, a gesture that the user can take while the cursor in the second location is displayed is not limited to the aforementioned examples.

The display apparatus 100 may identify whether the first sensing data and the second sensing data are matched. Here, the second sensing data may fall under data obtained by sensing the third motion through the motion sensor 160. Here, the first sensing data may fall under data obtained through a separate motion sensor provided in an external apparatus.

Here, the feature that the first sensing data and the second sensing data are matched may mean a state wherein specific characteristics (e.g., waveform patterns, frequency components, temporal changes, etc.) of the two pieces of sensing data are the same or show similar aspects.

For example, the display apparatus 100 may extract a change of acceleration according to time from each of the first sensing data and the second sensing data. Here, the change of acceleration according to time may mean a change during a period wherein the third motion (or the first motion, etc.) was generated and ended.

If changes of acceleration of each of the first sensing data and the second sensing data show similar aspects, the display apparatus 100 may identify that the first sensing data and the second sensing data are matched.

Here, the feature of showing similar aspects may mean a state wherein values such as a dynamic time warping (DTW) distance, a correlation coefficient, or a mean squared error (MSE), etc. between signals (e.g., acceleration according to time) converge to greater than or equal to a set threshold.

Meanwhile, if it is identified that the first sensing data and the second sensing data are matched, the display apparatus 100 may obtain biological motion information based on the first sensing data and the second sensing data.

Here, the display apparatus 100 may obtain biological motion information by inputting data including the first sensing data and the second sensing data into the aforementioned first neural network model.

For example, the display apparatus 100 may obtain biological motion information corresponding to not only a motion of the external apparatus but also a motion of the display apparatus 100 by using the second sensing data as well as the first sensing data.

As described above, as the display apparatus 100 identifies whether the second sensing data that it obtained by sensing by itself is matched with the first sensing data first, a malfunction of the cursor according to an unintentional motion of the body (e.g., a case wherein the user moves a finger while not gripping the display apparatus 100, etc.) can be prevented.

Meanwhile, in a normal situation (e.g., a case wherein the user contacted a fingertip on the rear surface of the display apparatus 100 while gripping the display apparatus 100), the display apparatus 100 may identify that the first sensing data and the second sensing data are matched.

In this case, the display apparatus 100 may recognize that the biological motion is an intentional motion, and obtain biological motion information based on the first sensing data and the second sensing data.

Meanwhile, if the cursor satisfies a specific condition in a state wherein the cursor is inactivated, the display apparatus 100 may convert the cursor to an activated state. Here, the state wherein the cursor is inactivated may mean a state wherein the cursor is not displayed and a function using the cursor cannot be used.

According to one or more embodiments, the display apparatus 100 may obtain a distance between the external apparatus and the display apparatus 100 based on the first initial sensing data obtained through the UWB sensor 150. Here, the first initial sensing data may fall under sensing data obtained through the UWB sensor 150 before there was a motion for activating the cursor.

For example, the first initial sensing data may include information on a Time of Flight (ToF), a Time of Arrival (ToA), a Round Trip Time (RTT), etc. For example, the ToF may mean the time that is taken until a signal transmitted from the UWB sensor 150 is reflected on a target object (the external apparatus), and is received again.

The display apparatus 100 may obtain a distance to the external apparatus (or the UWB sensor of the external apparatus) by using the ToF, etc.

The display apparatus 100 may identify whether the distance between the external apparatus and the display apparatus 100 is smaller than the defined distance. Here, as the defined distance was explained in detail above, overlapping explanation will be omitted.

The display apparatus 100 may identify whether the cursor was activated according to whether the aforementioned distance is smaller than the defined distance.

As an example, if the distance is smaller than the defined distance, the display apparatus 100 may receive the second initial sensing data from the external apparatus through the communication circuitry 120. Here, the second initial sensing data may fall under data generated by a gesture for activating the cursor.

For example, in case the user taps (or double taps) the rear surface of the display apparatus 100 through a fingertip for activating the cursor, the external apparatus may obtain the second initial sensing data by sensing a motion of the external apparatus by the motion of the fingertip. The external apparatus may transmit the obtained second initial sensing data to the display apparatus 100.

Meanwhile, if it is identified that the third initial sensing data and the second initial sensing data are matched with a defined gesture pattern, the display apparatus 100 may identify that the cursor was activated.

Here, the third initial sensing data may fall under data obtained by sensing a motion corresponding to a gesture through the at least one motion sensor 160. Here, the motion corresponding to a gesture may fall under a motion of the display apparatus 100 according to a gesture for activating the cursor (e.g., tapping, etc.).

Here, the defined gesture pattern may fall under a pattern obtained by repeatedly sensing gestures for each of several types (up, down, left, right, etc.) of the user, and analyzing the sensing data obtained therefrom. Here, the pattern may mean aspects of specific characteristics (e.g., waveforms, frequencies, temporal changes, etc. of speed, acceleration, a tilt, etc.) of the sensing data.

For example, in case the user moved a fingertip in each of up, down, left, and right directions by a plurality of times, the display apparatus 100 may sense the motions of the fingertip through the motion sensor 160. Also, the external apparatus may sense the motions of the user’s fingertip as above. Accordingly, the display apparatus 100 and the external apparatus may respectively obtain the previous sensing data.

The display apparatus 100 may extract a pattern that commonly appears in the previous sensing data obtained by the display apparatus 100 and the previous sensing data obtained by the external apparatus.

For example, in case changes of acceleration and angular velocity according to time appear in similar aspects (waveforms) several times in each of the aforementioned two types of previous sensing data, the display apparatus 100 may obtain gesture patterns (e.g., average characteristics of several similar characteristics) from the characteristics of the waveforms that appeared similarly several times. Here, as the similar aspects were explained above, overlapping explanation will be omitted.

Meanwhile, the feature that the third initial sensing data and the second initial sensing data are matched with the defined gesture pattern may mean that each of the third initial sensing data and the second initial sensing data show similar aspects to the defined gesture pattern.

If it is identified that the second initial sensing data and the third initial sensing data show similar aspects, the display apparatus 100 may identify that the cursor was activated.

If it is identified that the cursor was activated, the display apparatus 100 may control the display 130 to display the cursor.

For example, the display apparatus 100 may control the display 130 to display the cursor in the initial location. For example, the display apparatus 100 may display the cursor on a central point of a screen wherein the cursor is not displayed (a screen wherein the cursor was inactivated). In this case, in order that the user can visually recognize that the cursor was activated, the display apparatus 100 may repeat a process of removing the cursor displayed on the screen and then displaying the cursor. However, the disclosure is not limited thereto.

Meanwhile, if it is identified that the cursor was activated, the display apparatus 100 may receive the first sensing data. The display apparatus 100 may display the screen wherein the cursor was moved to the second location by performing the aforementioned process such as obtaining biological motion information from the received first sensing data.

As described above, the display apparatus 100 may activate the cursor only when both of two conditions are satisfied. Here, the two conditions may respectively fall under a condition wherein the distance between the display apparatus 100 and the external apparatus is smaller than the defined distance, and a condition wherein the second initial sensing data and the third initial sensing data are matched.

In other words, as in a case wherein the user moves a finger when the user is not gripping the display apparatus 100, there may be a case wherein there is an unintentional motion of the body. If the display apparatus 100 does not perform the aforementioned initial activation process, the cursor may move by such an unintentional motion, and thus a motion not intended by the user may be performed in the display apparatus 100.

In case the cursor is initially activated only when the two conditions are satisfied, the display apparatus 100 may prevent such an unintentional motion from being performed. The display apparatus 100 may move the cursor to a location that is more appropriate for the user intent by making the user view the cursor displayed in the initial location of the cursor (e.g., the central location of the screen) and perform a gesture for moving the cursor to a desired location.

Meanwhile, in FIG. 3, the display apparatus 100 including various additional components was illustrated, but the display apparatus 100 may be implemented in a form wherein some components among the illustrated components are omitted. Also, although not illustrated in the drawing, the display apparatus 100 may further include other components.

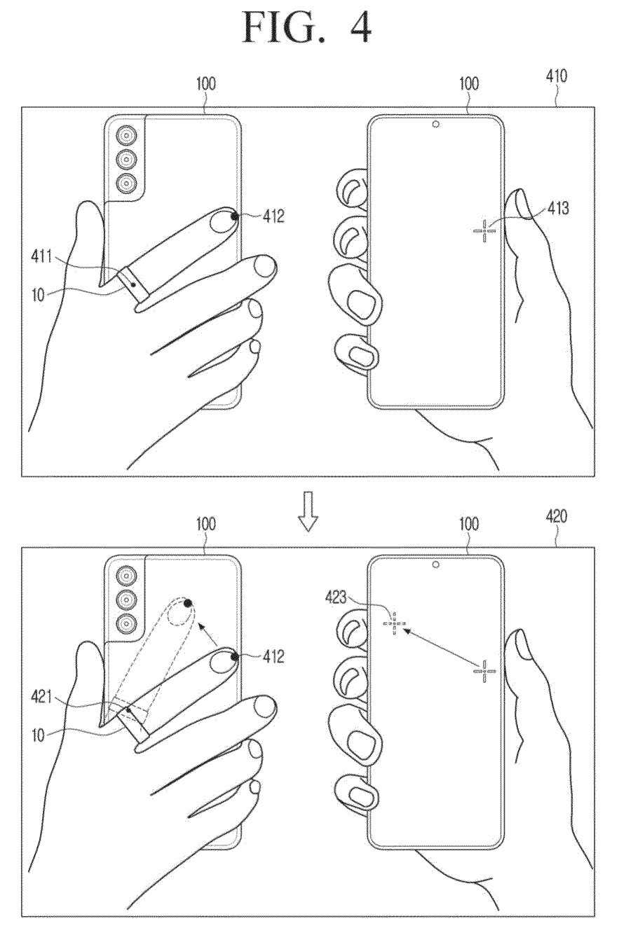

FIG. 4 is a diagram for illustrating an operation of a display apparatus according to one or more embodiments of the disclosure.

According to FIG. 4, a first state 410 and a second state 420 of the display apparatus 100 are illustrated.

The first state 410 may indicate a state before the cursor 413 moves, and the second state may mean a state after the cursor 423 moved.

In both of the first state 410 and the second state 420, the external apparatus 100 may be worn on an index finger. Here, the index finger may mean a finger that the user will move for moving the cursor through the external apparatus 10 in case the user controls the display apparatus 100 by using a finger.

FIG. 4 illustrates a case wherein the external apparatus 10 is worn on an index finger, but this is merely an example, and the external apparatus 10 can obviously be worn on other fingers (a thumb, a middle finger, a ring finger, etc.).

According to the first state 410, while the fingertip 412 of the index finger is located on an initial point, the user may grip the display apparatus 100. In this case, while the fingertip 412 is located on the initial point, the external apparatus 10 worn on the index finger may be located in a first apparatus location 411. Here, the display apparatus 100 may perform a process of activating the cursor 413 as described above.

In this case, in case the cursor was activated, the display apparatus 100 may display the cursor 413 in a first cursor location. Here, the first cursor location may fall under a location wherein the cursor 413 is activated and is initially displayed.

In case the user moves the index finger (or the fingertip 412) for moving the cursor 413, the display apparatus 100 may change to the second state 420.

For example, the second state 420 may fall under a state wherein the fingertip 412 moved from the initial location to a new location after the movement of the index finger. According to the movement of the fingertip, the location of the external apparatus 10 may be moved from the first apparatus location 411 to the second apparatus location 421.

In this case, on the screen of the display apparatus 100, the moved cursor 423 may be displayed in the second cursor location. Here, the second location may fall under a location on the screen, which corresponds to the location of the fingertip 412 after moving.

The external apparatus 10 may obtain the first sensing data by sensing a motion of the external apparatus 10 while moving from the first apparatus location 411 to the second apparatus location 421, and the display apparatus 100 may obtain movement information of the fingertip from the first sensing data. Here, the movement information of the fingertip may fall under the aforementioned biological motion information.

The display apparatus 100 may obtain information of the cursor from the movement information of the fingertip, and display a screen wherein the cursor moved from the first location to the second location according to the movement information of the cursor. As the detailed operations that the display apparatus 100 performs to display a screen wherein the cursor was moved to the second location were explained in FIGS. 2 and 3, overlapping explanation will be omitted.

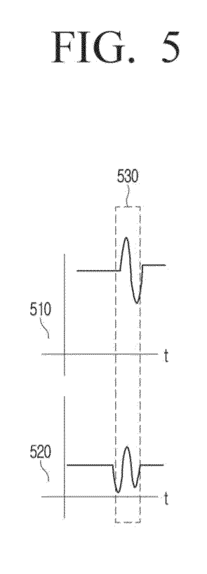

FIG. 5 is a diagram for illustrating sensing data according to one or more embodiments of the disclosure.

According to FIG. 5, first sensing data 510 and second sensing data 520 are illustrated.

Each of the first sensing data 510 and the second sensing data 520 may show a change of a specific parameter value according to time. For example, the specific parameter value may fall under acceleration. Here, the acceleration may be obtained from a sensor (a motion sensor or a UWB sensor) provided on the display apparatus 100 or an external apparatus.

Meanwhile, each of the first sensing data 510 and the second sensing data 520 may show similar aspects in a motion section 530. Here, the motion section may mean a section wherein the user moved a fingertip for moving the cursor. A case wherein there are similar aspects may mean a case wherein waveforms of parameters such as acceleration according to time, etc. are similar.

The display apparatus 100 may compare the first sensing data 510 and the second sensing data 520 and identify whether they are matched with each other. Here, if it is identified that similar aspects are shown in each of the first sensing data 510 and the second sensing data 520 in the motion section 530, the display apparatus 100 may identify that the first sensing data 510 and the second sensing data 520 are matched with each other.

For example, only when it is identified that the first sensing data 510 and the second sensing data 520 are matched, the display apparatus 100 may move the cursor to correspond to a motion of the user’s fingertip and display it.

In other words, in case the user is not using the display apparatus 100 such as a case wherein the external apparatus is far away from the display apparatus 100, etc., the display apparatus 100 may prevent the cursor on the display apparatus 100 from moving due to a motion of the fingertip.

Meanwhile, the display apparatus 100 may move the cursor and display it by using the sensing data obtained by the display apparatus 100 and the external apparatus. In this case, the display apparatus 100 may obtain information on a location to which the cursor will move by using one or more neural network models, and move the cursor to a location appropriate for the user’s motion and display it.

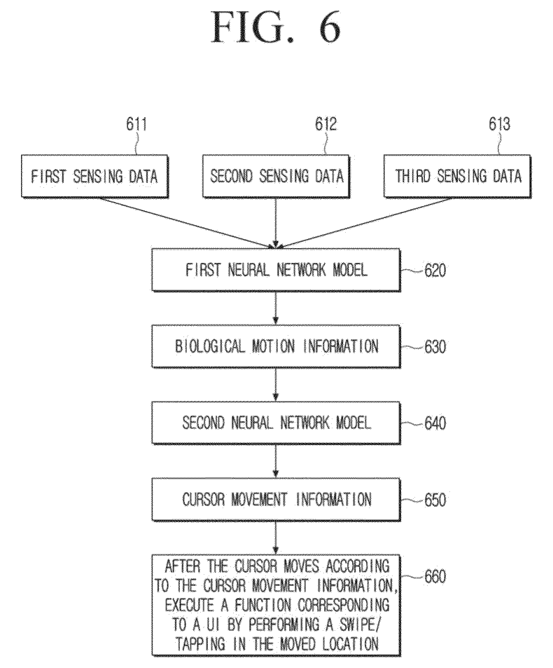

Detailed explanation in this regard will be described in FIG. 6.

FIG. 6 is a diagram for illustrating aspects of a first neural network model and a second neural network model according to one or more embodiments of the disclosure.

According to FIG. 6, the display apparatus 100 may move the cursor or execute a function corresponding to a UI by using a first neural network model 620 and a second neural network model 640.

As the first neural network model 620 and the second neural network model 640 were explained above, overlapping explanation will be omitted.

The first neural network model 620 may obtain biological motion information 630 by using the first sensing data 611, the second sensing data 612, and the third sensing data 613 as input data. Here, as the first sensing data 611, the second sensing data 612, and the biological motion information 630 were explained in detail above, overlapping explanation will be omitted.

The third sensing data 613 may fall under sensing data that the display apparatus 100 obtained through a UWB sensor. Here, the UWB sensor may fall under a sensor different from a sensor (e.g., a motion sensor) that the display apparatus 100 used for obtaining the second sensing data 612.

The UWB sensor may sense a distance (and a change of a distance) between the display apparatus 100 and the external apparatus. For example, the third sensing data 613 may include information on the distance between the display apparatus 100 and the external apparatus. As other detailed contents related to the UWB sensor were explained in detail above, overlapping explanation will be omitted.

Meanwhile, the first neural network model 620 may be trained based on the third previous sensing data that the display apparatus 100 obtained by sensing a previous motion of the external apparatus. In other words, the first neural network model 620 may be trained by using not only the first previous sensing data and the second previous sensing data obtained through the UWB sensor, etc., but also the third previous sensing data as training data.

In this case, the first neural network model 620 may be trained to output biological motion information corresponding to a specific distance or a change of a specific distance between the display apparatus 100 and the external apparatus.

The first neural network model 620 may be trained to output biological motion information by using other data as well as the aforementioned first sensing data 611 to third sensing data 613 as training data.

For example, the first neural network model 620 may also be trained based on image data obtained through the camera.

Specifically, the display apparatus 100 may obtain a plurality of images by capturing a specific motion of a finger, and assume a moving direction of the finger from the plurality of images. The display apparatus 100 may obtain new training data by labeling at least one of the first sensing data 611 to the third sensing data 613 according to the assumed moving direction of the finger. The display apparatus 100 may train the first neural network model 620 by using the training data obtained by labeling.

Meanwhile, the second neural network model 640 may output cursor movement information 650 by using the biological motion information 630 as input data. Here, the second neural network model 640 may be trained to output the cursor movement information 650 corresponding to a biological motion based on the first sensing data and the second sensing data by a biological motion.

Also, the display apparatus 100 may move the cursor according to the cursor movement information by using the obtained cursor movement information, and then execute a function corresponding to a UI as the user swipes or tapes in the moved location (660).

For example, the display apparatus 100 may move the cursor and display it by using the cursor movement information. Here, the display apparatus 100 may display a screen wherein the cursor moved from the first location to the second location.

Then, in case the cursor in the second location is located on a specific UI, the user may perform an operation such as a swipe or tapping. Here, the operation such as a swipe or tapping may mean a gesture by which the user selects the specific UI and performs a specific operation. Here, as a swipe or tapping was explained in detail above, overlapping explanation will be omitted.

The display apparatus 100 may receive sensing data generated by the user’s swipe or tapping from the external apparatus. Alternatively, the display apparatus 100 may obtain sensing data by sensing the user’s swipe or tapping.

The display apparatus 100 may recognize that there is a swipe or tapping of the user, and execute a function corresponding to the UI. For example, in case an icon of a specific application was displayed in the second location, the display apparatus 100 may execute the application. However, the disclosure is not limited thereto.

As described above, the display apparatus 100 may move the cursor or execute a function corresponding to a UI in the location to which the cursor moved by using both of the first neural network model 620 and the second neural network model 640.

Hereinafter, an operation of the display apparatus 100 of training the first neural network model 620 and the second neural network model 640 will be explained.

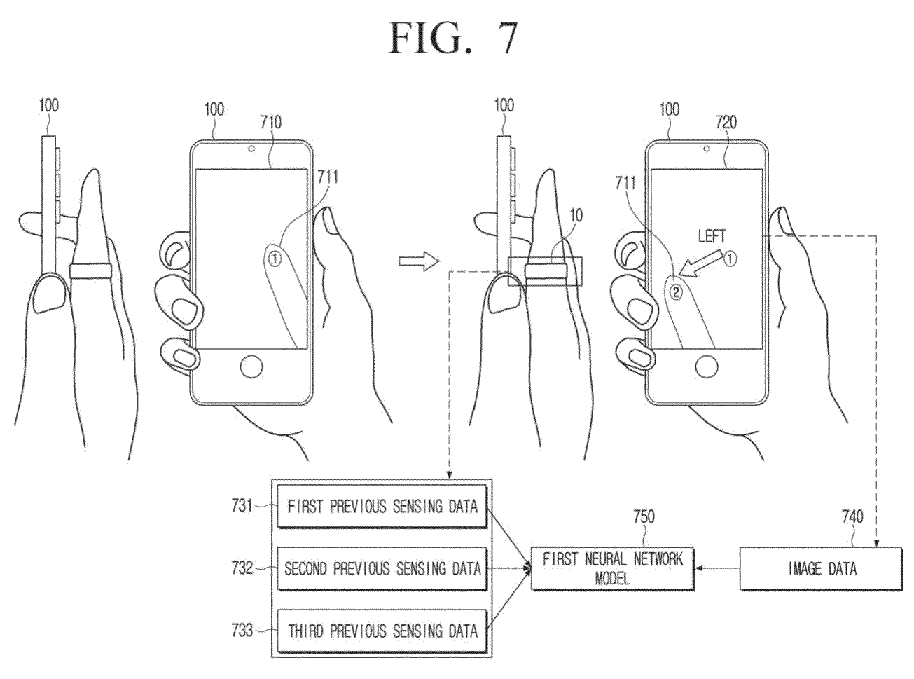

FIG. 7 is a diagram for illustrating aspects of a first neural network model according to one or more embodiments of the disclosure.

According to FIG. 7, the display apparatus 100 may capture a fingertip 711 in an initial location and a fingertip 721 after moving as the user of the display apparatus 100 moves the fingertip. Here, the fingertip may fall under a fingertip of the finger wearing the external apparatus 10.

The display apparatus 100 may obtain image data 740 by capturing the motion of the fingertip. Here, the image data may include a plurality of images.

Here, the plurality of images may fall under a plurality of images obtained by capturing by a specific interval according to the movement of the finger. Here, the plurality of obtained images are consecutive still images (frames), and may fall under an image data set reflecting a change according to time.

For example, in case the fingertip 711 in the initial location was recognized through the camera, the display apparatus 100 may display a first UI displayed as ‘1’ on the fingertip in the initial location. When the first UI is displayed, the display apparatus 100 may display a second UI displayed as ‘2’ on the left side by a specific interval from the first UI together with a left arrow. Along with this, the display apparatus 100 may display a third UI displayed as ‘LEFT.’ The third UI may fall under a UI that directs the user to move the fingertip to the left side. The second UI may mean a location to which the fingertip will move.

The user may move the fingertip to the left side as the first UI to the third UI are displayed, and the display apparatus 100 may obtain a plurality of images by capturing the fingertip by a defined time interval. Here, the plurality of images may be implemented as a plurality of frames included in a video.

According to FIG. 7, explanation was described by suggesting a case wherein a fingertip of the user moves to the left side as an example. However, the disclosure is not necessarily limited thereto, and in case a fingertip moves in a plurality of other predetermined directions (e.g., up, down, right, etc.), the display apparatus 100 may repeatedly perform the same process.

The display apparatus 100 may obtain a moving direction of the fingertip by analyzing the plurality of images (frames) included in the image data. Specifically, the display apparatus 100 may calculate a change of the coordinate of the fingertip through tracking of feature points (e.g., optical flow, CNN based keypoint detection) among consecutive images (frames), and assume the moving direction and output it in a form of a vector.

For example, the display apparatus 100 may recognize that the moving direction of the fingertip is the left side from image data obtained as the fingertip moved to the left side. The display apparatus 100 may repeatedly perform the same process in case the fingertip moves in the plurality of other predetermined directions (e.g., up, down, right, etc.).

The display apparatus 100 may obtain the first previous sensing data 731, the second previous sensing data 732, and the third previous sensing data generated by a motion of the external apparatus 10.

Here, as the first previous sensing data 731 and the second previous sensing data 732 were explained in detail in FIG. 2, overlapping explanation will be omitted.

The third previous sensing data may fall under sensing data that the display apparatus 100 previously obtained through the UWB sensor.

For example, in case the external apparatus 10 moves according to a motion of the user’s fingertip, the display apparatus 100 may obtain the third previous sensing data 733 through the UWB sensor.

The display apparatus 100 may include a plurality of distances obtained by a defined interval according to a movement of the external apparatus 10 based on the third previous sensing data 733. In other words, the third previous sensing data 733 may include information regarding in a how much distanced state the external apparatus 10 moved from the display apparatus 100.

Meanwhile, the first neural network model 750 may be trained to obtain biological motion information based on the first previous sensing data 731, the second previous sensing data 732, the third previous sensing data 733, and the image data.

In this case, the display apparatus 100 may label at least one of the first previous sensing data 731, the second previous sensing data 732, or the third previous sensing data 733 by using a specific direction identified from the image data. Here, as labeling was explained in detail above, overlapping explanation will be omitted.

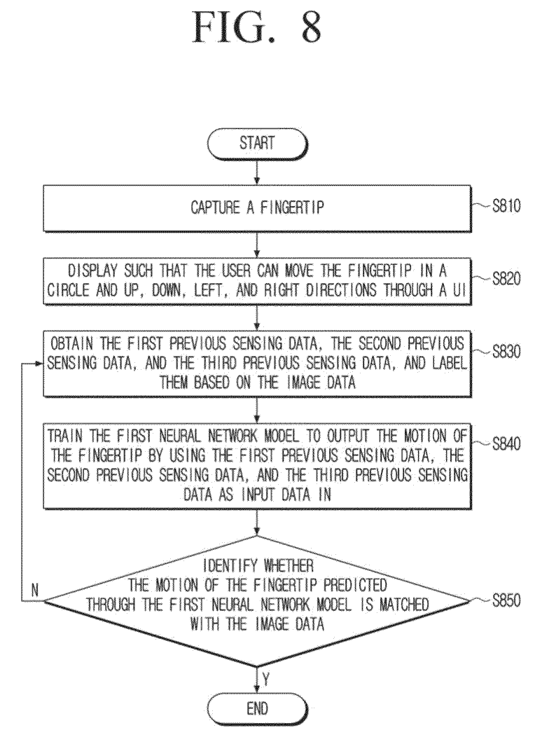

FIG. 8 is a flow chart for illustrating aspects of a first neural network model according to one or more embodiments of the disclosure.

The display apparatus 100 may capture a fingertip in the step S810. For example, the display apparatus 100 may capture a fingertip located in an initial location.

Then, the display apparatus 100 may display such that the user can move the fingertip in a circle and up, down, left, and right directions through a UI in the step S820. For example, the display apparatus 100 may display a UI (e.g., a first UI to a third UI) that directs to move the fingertip in a specific direction, and if the user moves in a specific direction, the display apparatus 100 may display a UI corresponding to a different direction and repeat the same process.

In case the user moves the fingertip according to the UI (e.g., the first UI to the third UI) displayed on the display apparatus 100, the display apparatus 100 may obtain image data by capturing the moving fingertip by a defined time interval.

Then, the display apparatus 100 may obtain the first previous sensing data, the second previous sensing data, and the third previous sensing data, and label them based on the image data in the step S830. For example, the display apparatus 100 may label specific directions (up, down, left, right, etc.) obtained based on the image data to the first previous sensing data, the second previous sensing data, and the third previous sensing data.

Then, the display apparatus 100 may train the first neural network model to output the motion of the fingertip by using the first previous sensing data, the second previous sensing data, and the third previous sensing data as input data in the step S840. Here, the motion of the fingertip may mean the aforementioned biological motion information.

Then, the display apparatus 100 may identify whether the motion of the fingertip predicted through the first neural network model is matched with the image data in the step S850.

Here, the motion of the fingertip predicted through the first neural network model may fall under a result output by the first neural network model in the case of inputting the current sensing data (e.g., the first sensing data, the second sensing data, and the third sensing data, etc.) into the first neural network model trained by test input data.

Here, the feature that the predicted motion of the fingertip is matched with the image data may mean a case wherein the motion (direction) of the fingertip output as a result coincides with the labeled direction. In other words, the feature that the predicted motion of the fingertip is matched with the image data may mean that the first neural network model was trained to be able to precisely predict a direction of a fingertip.

In case the predicted motion of the fingertip is matched with the image data, the display apparatus 100 may complete the process of training the first neural network model.

In contrast, in case the predicted motion of the fingertip is not matched with the image data, the display apparatus 100 may obtain the first previous sensing data, the second previous sensing data, and the third previous sensing data, and label them based on the image data in the step S830, and repeat the aforementioned subsequent processes.

In other words, in case the predicted motion of the fingertip is not matched with the image data, the display apparatus 100 may additionally obtain the first previous sensing data, the second previous sensing data, and the third previous sensing data, and train the first neural network model by using the increased training data.

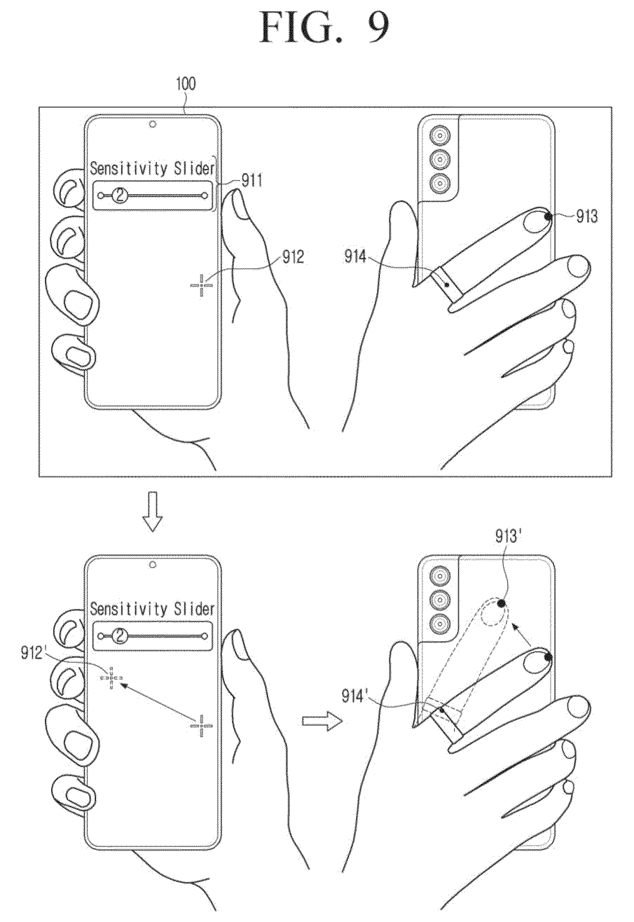

FIG. 9 is a diagram for illustrating aspects of a second neural network model according to one or more embodiments of the disclosure.

According to FIG. 9, a process wherein the display apparatus 100 trains a second neural network model based on a movement of a test cursor in a first cursor location 912 is illustrated. Here, the first cursor location 912 may fall under a location wherein the test cursor is activated and is initially displayed.

In an initial state, the display apparatus 100 may display a sensitivity slider 911 and the test cursor in the first cursor location 912.

Here, the display apparatus 100 may be in a state of having been gripped by a finger wearing an external apparatus. Here, the external apparatus may fall under an apparatus worn on the first apparatus location 914. Here, the fingertip of the finger wearing the external apparatus may be located on a first biological location 913.

Meanwhile, the display apparatus 100 may display a screen wherein the sensitivity slider 911 is set as the stage 2. Here, the sensitivity slider 911 may fall under a UI that enables the user to adjust sensitivity. Here, the sensitivity may mean a ratio of a moving degree of the fingertip and a moving degree of the cursor. Here, the ratio may be expressed as (a moving distance of the cursor)/(a moving distance of the fingertip), etc.

Meanwhile, the display apparatus 100 may display a screen in a state wherein the cursor was moved from the first cursor location 912 to the second cursor location 912’. Here, the screen may fall under a screen that directs the user to view the cursor moved to the second cursor location 912’ and move the fingertip.

The user may view the screen as above and move the fingertip from the first biological location 913 to the second biological location 913’. Accordingly, the external apparatus may move from the first apparatus location 914 to the second apparatus location 914’.

Here, the user may view the degree by which the cursor moved from the first cursor location 912 to the second cursor location 912’, and move the fingertip to be appropriate for the moving degree. For example, the user may move the fingertip such that the cursor moves according to the fingertip located on the rear surface of the display apparatus 100.

The display apparatus 100 may obtain the previous sensing data (e.g., the first previous sensing data to the third previous sensing data) as the external apparatus moves from the first apparatus location 914 to the second apparatus location 914’.

The display apparatus 100 may train the second neural network model based on the obtained previous sensing data. In other words, the display apparatus 100 may train the second neural network model to output cursor movement information.

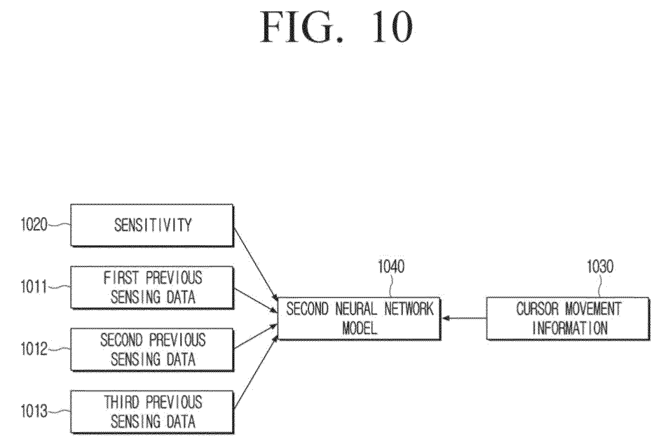

FIG. 10 is a diagram for illustrating aspects of a second neural network model according to one or more embodiments of the disclosure.

According to FIG. 10, the first previous sensing data 1011, the second previous sensing data 1012, the third previous sensing data 1013, sensitivity 1020, cursor movement information 1030, and a second neural network model 1040 are illustrated.

Here, the display apparatus 100 may train the second neural network model 1040 by using the first previous sensing data 1011, the second previous sensing data 1012, the third previous sensing data 1013, the sensitivity 1020, and the cursor movement information 1030 as training data.

Here, the first previous sensing data 1011, the second previous sensing data 1012, and the third previous sensing data 1013 may fall under sensing data that was obtained according to a movement of an external apparatus in case the external apparatus moves as a fingertip moves. As other detailed contents regarding each of the first previous sensing data 1011, the second previous sensing data 1012, and the third previous sensing data 1013 were explained above, overlapping explanation will be omitted.

The sensitivity 1020 may mean the sensitivity set by the user while a test cursor is displayed. According to the example in FIG. 9, the sensitivity may be set as the stage 2.

For example, in case the user moved a fingertip according to a movement of the test cursor, the sensitivity may be obtained as a result of subdividing the moving distance of the test cursor by the moving distance of the fingertip. Here, the moving distance of the fingertip may be obtained by the first previous sensing data.

The cursor movement information 1030 may include a direction and a distance, etc. in which the test cursor moved. According to the example in FIG. 9, the cursor movement information 1030 may include information that the cursor moved by a specific distance in the upper left direction.

The second neural network model 1040 may be trained to output cursor movement information corresponding to at least one of the first previous sensing data 1011, the second previous sensing data 1012, the third previous sensing data 1013, or the sensitivity 1020.

For example, in case the second neural network model 1040 was trained to output cursor movement information corresponding to the sensitivity set as the stage 2, the second neural network model 1040 may obtain cursor movement information appropriate for the sensitivity which is the stage 2 while the current sensitivity is set as the stage 2.

However, the disclosure is not limited thereto, and in case the current sensitivity is set as other stages (stages 1, 3, 4, etc.), the second neural network model 1040 may obtain cursor movement information appropriate for the sensitivity of each of the other stages.

For example, as the stage of the sensitivity becomes lower, the moving distance of the cursor per unit moving distance of a fingertip may appear to be shorter. In contrast, as the stage of the sensitivity becomes higher, the moving distance of the cursor per unit moving distance of a fingertip may appear to be longer.

As described above, the second neural network model 1040 may be trained by various types of training data, and detailed operations in this regard will be explained in the parts described below.

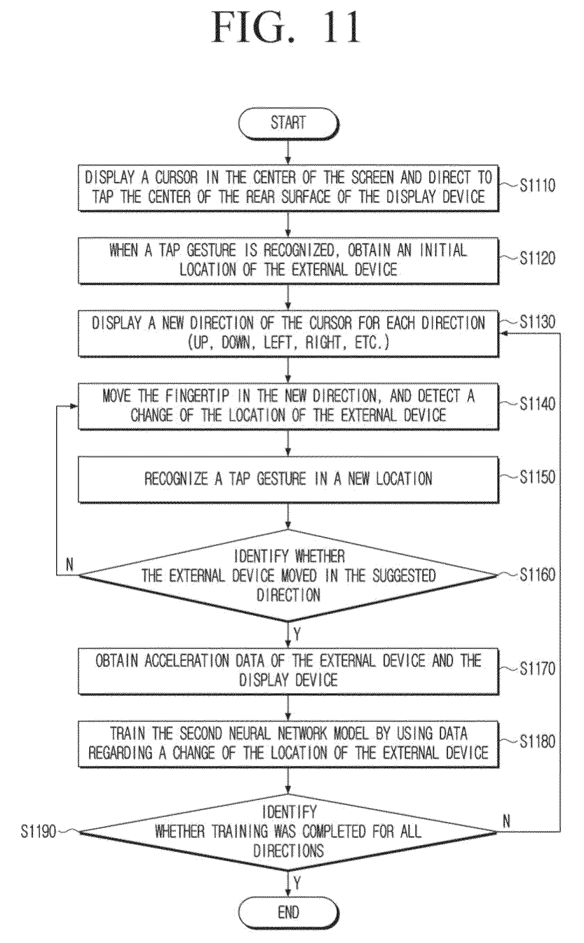

FIG. 11 is a flow chart for illustrating aspects of a second neural network model according to one or more embodiments of the disclosure.

The display apparatus 100 may display a cursor in the center of the screen and direct to tap the center of the rear surface of the display apparatus 100 in the step S1110. The display apparatus 100 may display a UI directing the user to tap with a finger wearing an external apparatus on the screen. For example, the display apparatus 100 may display a text such as ‘Tap the rear surface with the finger wearing the smart ring’ on the screen.

Then, when a tap gesture is recognized, the display apparatus 100 may obtain an initial location of the external apparatus in the step S1120. For example, if it is recognized that the cursor was activated, the display apparatus 100 may display the initial location of the external apparatus. Here, as the meaning of the feature that the cursor was activated was explained in detail above, overlapping explanation will be omitted.

Here, the initial location of the external apparatus may be obtained by a sensor (e.g., a UWB sensor, a motion sensor, and an image sensor (a camera), etc.) provided on the display apparatus 100.

Then, the display apparatus 100 may display a new direction of the cursor for each direction (up, down, left, right, etc.) in the step S1130. Here, each direction may fall under a direction included in the plurality of predetermined directions (up, down, left, right, etc.). For example, the display apparatus 100 may display a direction of the cursor through a UI in a form of an arrow.

Then, a fingertip moves in the new direction, and the display apparatus 100 may detect a change of the location of the external apparatus in the step S1140. For example, the user may view the displayed new direction and move a fingertip, and the display apparatus 100 may detect a change of the location of the external apparatus according to moving of the fingertip. For example, the display apparatus 100 may obtain sensing data (the first previous sensing data and the second previous sensing data, etc.) regarding a change of the distance to the external apparatus and a change of the acceleration of the external apparatus, etc. according to moving of the fingertip.

Then, the display apparatus 100 may recognize a tap gesture in a new location in the step S1150. Here, the gesture may fall under an operation of the user for finishing moving of the fingertip. For example, the user may move the fingertip by viewing the arrow displayed on the screen and the cursor in the target location (the second cursor location), and then tap the fingertip on the rear surface of the display apparatus 100 in the moved location.

Then, the display apparatus 100 may identify whether the external apparatus moved in the suggested direction in the step S1160. Here, the suggested direction may mean a direction indicated through the arrow on the screen.

Here, the display apparatus 100 may identify whether the external apparatus moved in the suggested direction through the sensor provided on the display apparatus 100.

For example, the display apparatus 100 may identify the location of the external apparatus in a location wherein a tap gesture was recognized from sensing data obtained through the sensor (distance data, image data, motion data (acceleration, speed, angular velocity, etc.) and the like). Then, the display apparatus 100 may identify whether the location of the external apparatus was changed, and identify whether the external apparatus moved in the suggested direction.

If it is identified that the external apparatus did not move in the suggested direction, the fingertip may move in a new direction again, and the display apparatus 100 may detect a change of the location of the external apparatus in the step S1140. In other words, if the external apparatus does not move in the target direction, the user may move the fingertip from the initial location to the target location such that the cursor is moved from the initial location to the target location. Accordingly, the display apparatus 100 may recognize a tap gesture in a new location again, and repeatedly perform the same process.

In contrast, if it is identified that the external apparatus moved in the suggested direction, the display apparatus 100 may obtain acceleration data of the external apparatus and the display apparatus 100 in the step S1170.

For example, if it is identified that the external apparatus moved in the targeted direction, the display apparatus 100 may recognize that the fingertip moved in a correct direction. In this case, the display apparatus 100 may obtain acceleration data of the external apparatus.

Specifically, the display apparatus 100 may receive the acceleration data obtained by the external apparatus. Here, the acceleration data obtained by the external apparatus may fall under data that the external apparatus obtained by sensing a motion of the external apparatus.

Then, the display apparatus 100 may train the second neural network model by using data regarding a change of the location of the external apparatus in the step S1180.

Here, the data regarding a change of the location may include the aforementioned first previous sensing data to third previous sensing data. For example, the data regarding a change of the location may include a distance to the external apparatus that the display apparatus 100 obtained through a sensor (e.g., a UWB sensor).

The display apparatus 100 may train the second neural network model to output cursor movement information by using the data as above. Here, as the operation of training the second neural network model was explained in detail above, overlapping explanation will be omitted.

Then, the display apparatus 100 may identify whether training was completed for all directions in the step S1190. Here, all directions may mean the plurality of predetermined directions (e.g., up, down, left, right, etc.).

The feature that training was completed for all directions does not mean that the second neural network model is trained by necessarily obtaining training data once for each direction.

For example, the display apparatus 100 may obtain training data for one direction a plurality of times and train the second neural network model for the direction. Here, the feature of obtaining training data may mean a process wherein the display apparatus 100 senses a motion of the external apparatus and obtains data regarding a change of the location of the external apparatus.

If it is identified that training for all directions was not completed yet, the display apparatus 100 may display a new direction of the cursor for each direction (up, down, left, right, etc.) again in the step S1130. Here, each direction may mean a direction wherein training was not completed among up, down, left, and right directions.

The fingertip may move in the new direction, and the display apparatus 100 may repeat the aforementioned subsequent processes such as detecting a change of the location of the external apparatus, etc.

If it is identified that training for all directions was completed, the display apparatus 100 may complete the process of training the second neural network model. Accordingly, the second neural network model may be trained to obtain cursor movement information corresponding to moving of the fingertip.

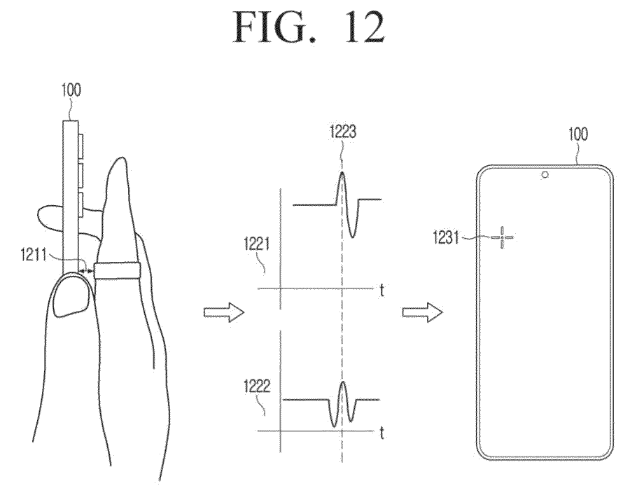

FIG. 12 is a diagram for illustrating an operation of activating a cursor according to one or more embodiments of the disclosure.

According to FIG. 12, a process wherein the cursor 1231 of the display apparatus 100 is activated is illustrated.

The display apparatus 100 may perform a process of activating the cursor 1231 first, before obtaining sensing data corresponding to a biological motion (e.g., a motion of a fingertip) of the user. Here, the display apparatus 100 may activate the cursor 1231 in case at least one defined condition is satisfied. In case the cursor 1231 was activated, the display apparatus 100 may display the cursor 1231 on the screen.

Here, the at least one condition may include a first condition and a second condition. Hereinafter, examples of the first condition and the second condition will be explained.

The display apparatus 100 may identify an interval 1211 between the display apparatus 100 and the external apparatus 10. For example, the display apparatus 100 may obtain the first initial sensing data (e.g., ToF) through the UWB sensor, and identify the interval 1211 based on the obtained sensing data.

If it is identified that the interval 1211 is smaller than a defined value, the display apparatus 100 may identify that the first condition is satisfied. If the interval 1211 is smaller than the defined value, the display apparatus 100 may identify that the fingertip contacted the display apparatus 100 (or the rear surface of the display apparatus 100) or is close to it, such as within a predetermined range which may regard value-to-value analysis per time, similarity of multiple values over some set amount of time, or the like.

Meanwhile, if it is identified that the second initial sensing data 1221 and the third initial sensing data 1222 are matched with a defined gesture pattern, the display apparatus 100 may identify that the second condition is satisfied.

For example, the display apparatus 100 may analyze acceleration included in each of the second initial sensing data 1221 and the third initial sensing data 1222, and identify whether each of the second initial sensing data 1221 and the third initial sensing data 1222 is matched with the defined gesture pattern. Here, the acceleration may mean a change of acceleration according to time.

Specifically, the display apparatus 100 may analyze aspects of changes of the acceleration on a specific time point 1223. In other words, the display apparatus 100 may compare aspects of changes of the acceleration of each of the second initial sensing data 1221 and the third initial sensing data 1222 according to time on the specific time point 1223. Here, the specific time point may fall under a time point when the user performed a gesture for activating the cursor.

Here, the second initial sensing data 1221 may fall under data that the external apparatus 10 obtained by sensing a gesture of the user. The third initial sensing data 1222 may fall under data that the display apparatus 100 obtained by sensing the aforementioned gesture of the user. Here, the user’s gesture may fall under a hand gesture (e.g., tapping, double tapping, etc.) that the user takes for the display apparatus 100 to activate the cursor.

Here, as the process wherein the display apparatus 100 compares the initial sensing data with the defined gesture pattern and identifies whether they are matched was explained in detail in FIG. 3, overlapping explanation will be omitted.

If it is identified that the initial sensing data is matched with the gesture pattern, the display apparatus 100 may identify that the fingertip contacted the display apparatus 100 (or the rear surface of the display apparatus 100) or is close to it, such as within a predetermined range which may regard value-to-value analysis per time, similarity of multiple values over some set amount of time, or the like.

If it is identified that both of the first condition and the second condition were satisfied, the display apparatus 100 may activate the cursor 1231 and display it on the screen. In this case, the display apparatus 100 may display the activated cursor 1231 in the initial location. Here, the initial location may fall under the aforementioned first location.

According to FIG. 12, it was illustrated that the activated cursor 1231 is displayed in the first location located on the upper left end, but this is merely an example, and the activated cursor 1231 may be displayed in another location on the screen of the display apparatus 100. Here, the activated cursor 1231 may be displayed in a location that can be set by the user in advance.

Accordingly, the display apparatus 100 may identify whether the state of the display apparatus 100 satisfies a defined condition, and perform a pre-activation process for moving the cursor 1231. Through this, in case the external apparatus 10 is not in a normal state like being too far away from the display apparatus 100, etc., a malfunction of the display apparatus 100 according to an unintentional motion of the user can be prevented.

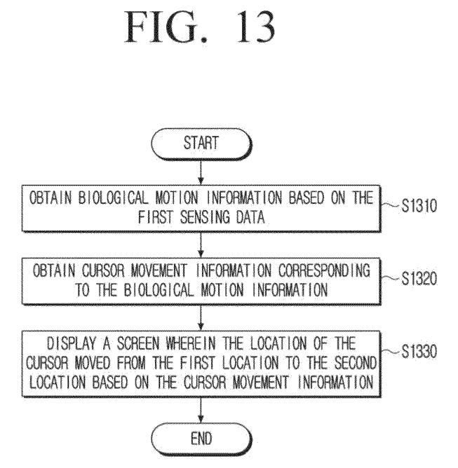

FIG. 13 is a flow chart for illustrating a control method of a display apparatus according to one or more embodiments of the disclosure.

The display apparatus 100 may obtain biological motion information based on the first sensing data in the step S1310.

According to one or more embodiments, the display apparatus 100 may receive the generated first sensing data from an external apparatus. Here, the first sensing data may fall under data generated by a second motion of the external apparatus according to a first motion of the body.

Then, the display apparatus 100 may obtain biological motion information corresponding to the first motion based on the first sensing data.

Then, the display apparatus 100 may obtain cursor movement information corresponding to the biological motion information in the step S1320.

Then, the display apparatus 100 may display a screen wherein the location of the cursor moved from the first location to the second location based on the cursor movement information.

According to one or more embodiments, the display apparatus 100 may display a screen wherein the location of the cursor moved from the first location to the second location based on the cursor movement information. Here, the first location may fall under a location wherein the cursor is activated and is initially displayed.

Then, the display apparatus 100 may display a screen wherein the location of the cursor moved from the first location to the second location based on the cursor movement information in the step S1330.

As described above, the display apparatus 100 may change the location of the cursor based on a motion of the body wearing the external apparatus. Even when the user is not directly wearing the external apparatus on a part (e.g., a fingertip) of the body that the user substantially wants to move, the display apparatus 100 may predict a motion of the part of the body from a motion of the external apparatus.

As the display apparatus 100 can move the cursor to correspond to a predicted motion of a part of the body, even when the display apparatus 100 does not include a component such as a track pad (a touch pad), the user can be provided with a use experience of being able to control the display apparatus 100 through a virtual track pad.

Also, there may be a case wherein the external apparatus and the display apparatus 100 are far away from each other such as a state wherein the user wearing the external apparatus is not gripping the display apparatus 100, etc. In this case, the display apparatus 100 may perform a process of activating the cursor in advance to prevent a malfunction due to a motion of the user.

Also, after the cursor is activated, the external apparatus and the display apparatus 100 may get far away from each other in the midway like when the user drops the display apparatus 100, etc.

In this case, for preventing a malfunction of the display apparatus 100 due to a motion of the user, the display apparatus 100 may identify whether the display apparatus 100 and the external apparatus are located close before the cursor moves, and determine whether to perform an operation afterwards.

Meanwhile, in FIG. 13, orders were mapped to all steps for the convenience of explanation, but it is obvious that the orders of steps that are not related to orders or that can be performed in parallel, etc. are not necessarily limited to the orders.

Meanwhile, methods according to at least some of the aforementioned various embodiments of the disclosure may be implemented in forms of applications that can be installed on conventional display apparatuses.

Also, the methods according to at least some of the aforementioned various embodiments of the disclosure may be implemented just with software upgrade, or hardware upgrade for a conventional display apparatus.

In addition, the methods according to at least some of the aforementioned various embodiments of the disclosure may be implemented through an embedded server provided on a display apparatus, or an external server of at least one of a display apparatus.

Meanwhile, according to one or more embodiments of the disclosure, the aforementioned various embodiments may be implemented as software including instructions stored in machine-readable storage media, which can be read by machines (e.g., computers). The machines refer to apparatuses that call instructions stored in a storage medium, and can operate according to the called instructions, and the apparatuses may include a display apparatus according to the aforementioned embodiments (e.g., a display apparatus). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘a non-transitory storage medium’ only means that the storage medium is a tangible apparatus, and does not include signals (e.g., electromagnetic waves), and the term does not distinguish a case wherein data is stored in the storage medium semi-permanently and a case wherein data is stored temporarily. For example, ‘a non-transitory storage medium’ may include a buffer wherein data is temporarily stored. Also, according to one or more embodiments, the methods according to the various embodiments described in the disclosure may be provided while being included in a computer program product. A computer program product refers to a product, and it can be traded between a seller and a buyer. A computer program product can be distributed in the form of a storage medium that is readable by machines (e.g., compact disc read only memory (CD-ROM)), or may be distributed directly between two user apparatuses (e.g., smartphones), and distributed on-line (e.g., download or upload) through an application store (e.g., Play Store ^{TM}). In the case of on-line distribution, at least a portion of a computer program product (e.g., a downloadable app) may be stored in a storage medium readable by machines such as the server of the manufacturer, the server of the application store, and the memory of the relay server at least temporarily, or may be generated temporarily.

Also, the various embodiments of the disclosure may be implemented as software including instructions stored in machine-readable storage media, which can be read by machines (e.g., computers). The machines refer to apparatuses that call instructions stored in a storage medium, and can operate according to the called instructions, and the apparatuses may include a display apparatus according to the aforementioned embodiments (e.g., the display apparatus 100).

In case the aforementioned instruction is executed by a processor, the processor may perform a function corresponding to the instruction by itself, or by using other components under its control. An instruction may include a code that is generated or executed by a compiler or an interpreter.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. A display apparatus comprising:
memory storing instructions;
communication circuitry;
a display configured to display a cursor; and
at least one processor comprising processing circuitry,
wherein the instructions, when executed by the at least one processor individually or collectively, cause the display apparatus to:
receive, from an external apparatus, through the communication circuitry, and according to a first motion of a body, first sensing data generated by a second motion of the external apparatus,
obtain, based on the first sensing data, biological motion information corresponding to the first motion,
obtain cursor movement information corresponding to the biological motion information, and
control the display to display a screen wherein the cursor is, based on the cursor movement information, moved from a first location to a second location.

2. The display apparatus of claim 1, further comprising:
an ultra-wide band (UWB) sensor,
wherein the instructions, when executed by the at least one processor individually or collectively, further cause the display apparatus to:
obtain, from the UWB sensor, a distance between the external apparatus and the display apparatus, and
based on determining the distance to be smaller than a defined distance, receive the first sensing data through the communication circuitry.

3. The display apparatus of claim 1, further comprising:
at least one motion sensor configured to sense a third motion of the display apparatus,
wherein the instructions, when executed by the at least one processor individually or collectively, further cause the display apparatus to:
based further on identifying that second sensing data is matched with the first sensing data, obtain the biological motion information, and the second sensing data is obtained from the at least one motion sensor.

4. The display apparatus of claim 1,
wherein the instructions, when executed by the at least one processor individually or collectively, further cause the display apparatus to:
obtain the biological motion information from a first neural network model that is trained to output the biological motion information according to previous sensing data and a first previous motion of the body.

5. The display apparatus of claim 4,
wherein the first neural network model is further trained to, based on the previous sensing data, output the biological motion information as further according to a second previous motion, and the previous sensing data comprises first previous sensing data and second previous sensing data, the first previous sensing data is obtained by sensing the second previous motion of the external apparatus, and the second previous motion of the external apparatus is obtained by sensing the first previous motion.

6. The display apparatus of claim 5,
wherein the second previous sensing data includes image data obtained by capturing, a plurality of times, the first previous motion in each of a plurality of directions, and
the first neural network model is further trained to output the biological motion information as including a direction of the plurality of direction and corresponding to the second previous motion.

7. The display apparatus of claim 1,
wherein the instructions, when executed by the at least one processor individually or collectively, further cause the display apparatus to:
obtain the cursor movement information from a second neural network model trained to output the cursor movement information according to previous sensing data and a first previous motion of the body.

8. The display apparatus of claim 7,
wherein the second neural network model is further trained to, based on the previous sensing data, output the cursor movement information according to a test cursor and the first previous motion of the body, and the previous sensing data is data obtained by sensing a second previous motion of the external apparatus, and the second previous motion of the external apparatus is corresponding to a movement of the test cursor.

9. The display apparatus of claim 2, further comprising:
an ultra-wide band (UWB) sensor,
wherein the instructions, when executed by the at least one processor individually or collectively, further cause the display apparatus to:
obtain a distance between the external apparatus and the display apparatus based on first initial sensing data obtained through the UWB sensor,
identify, according to whether the distance is determined to be smaller than a defined distance, whether the cursor was activated, and
based on identifying that the cursor was activated, receive the first sensing data.

10. The display apparatus of claim 9, further comprising:
at least one motion sensor configured to sense a third motion of the display apparatus,
wherein the instructions, when executed by the at least one processor individually or collectively, further cause the display apparatus to:
based on the distance being determined to be smaller than the defined distance, receive, from the external apparatus and through the communication circuitry, second initial sensing data generated by a gesture activating the cursor,
based on identifying that third initial sensing data and the second initial sensing data are matched with a defined gesture pattern, identify that the cursor was activated, the third initial sensing data is obtained by sensing a motion corresponding to the gesture through the at least one motion sensor, and
control the display to display the cursor.

11. A control method of a display apparatus, the method comprising:
receiving, from an external apparatus and according to a first motion of a body, first sensing data generated by a second motion of the external apparatus;
obtaining, based on the first sensing data, biological motion information corresponding to the first motion;
obtaining cursor movement information corresponding to the biological motion information; and
displaying a screen wherein a cursor is, based on the cursor movement information, moved from a first location to a second location.

12. The control method of claim 11,
wherein receiving the first sensing data comprises:
obtaining, from an ultra-wide band (UWB) sensor, a distance between the external apparatus and the display apparatus; and
based on determining the distance to be smaller than a defined distance, receiving the first sensing data.

13. The control method of claim 11,
wherein obtaining the biological motion information comprises:
based further on identifying that second sensing data is matched with the first sensing data, obtaining the biological motion information, and the second sensing data is obtained through at least one motion sensor configured to sense a third motion of the display apparatus.

14. The control method of claim 11,
wherein obtaining the biological motion information comprises:
obtaining the biological motion information from a first neural network model that is trained to output the biological motion information according to previous sensing data and a first previous motion of the body.

15. A non-transitory computer-readable recording medium storing computer instructions which, when executed by a processor of a display apparatus, cause the display apparatus to perform operations comprising:
receiving, from an external apparatus and according to a first motion of a body, first sensing data generated by a second motion of the external apparatus;
obtaining, based on the first sensing data, biological motion information corresponding to the first motion;
obtaining cursor movement information corresponding to the biological motion information; and
displaying a screen wherein a cursor is, based on the cursor movement information, moved from a first location to a second location.
